(19) United States
(12) Patent Application Publication
(10) Pub. No.: US 2024/0337133 A1
(43) Pub. Date: Oct. 10, 2024

(54) MULTIFUNCTIONAL STRENGTHENED LOCK STRUCTURE

(71) Applicant: Rick Te-Yu Chen, Pingtung City (TW)

(72) Inventor: Rick Te-Yu Chen, Pingtung City (TW)

(21) Appl. No.: 18/131,370

(22) Filed: Apr. 6, 2023

(51) Int. Cl. E05B 15/04; E05B 15/02; E05B 15/10

(52) U.S. Cl. CPC E05B 15/04; E05B 15/0205; E05B 15/10; E05B 2015/0462

(57) ABSTRACT

A multifunctional strengthened lock structure includes a case and a bolt control unit and a strengthened triangular latch unit arranged in the case. The bolt control unit includes an own-axis rotating plate, a first push plate, a second push plate, a butterfly plate and a first spring, a second spring, and a pressing member, and an arc arrestor. When a lock-cylinder rotating axle is rotated to close, the own-axis rotating plate is rotate to the closed position, and the second push plate is inoperable due to the butterfly plate being pushed to an idle position so as to serve as a blocking plate for the handle rotating axle, thereby achieving a dual-locking effect. A triangular latch includes a latching head, a rod pivotally connected to the latching head, a strengthening ring fit over the rod, and a strengthening screw fastened to the latching head and the rod.

### TECHNICAL FIELD OF THE INVENTION

The present invention relates to a multifunctional strengthened lock structure, and more particularly to a multifunctional strengthened lock structure that achieves a dual locking effect and strengthens a triangular latch by means of variation in respect of material, shape, and structure to thereby achieve a multifunctional strengthening effect.

### DESCRIPTION OF THE PRIOR ART

In addition to the commonly known parts, such as a square latch and a triangular latch, a lock structure also includes a bolt linking with the small latch. In a normal state, when rotated by a handle or a key, the lock makes the latch in a locked state. For a regular lock can be locked from the indoor side, and the way of operation of an existing lock is that locking is achieved by means of a rotating axle located indoors, and when located outdoors or in an attempt to enter indoors, a key is used to lock or unlock. To provide the lock with better effects of security and burglary resistance, in addition to having the latch to fit into the door frame for closing, there is no other effects for strengthening burglary resistance.

Further, the triangular latch included in a common lock is generally formed by pivoting a latching head to a rod, and based on the material and shape, as well as the design of structure thereof, the known triangular latch is not sufficient robust. The present invention aims to provide a multifunctional strengthened lock structure such that the lock achieves a dual locking effect and strengthens the triangular latch to thereby achieve a multifunctional strengthening effect.

### SUMMARY OF THE INVENTION

The primary objective of the present invention is to provide a multifunctional strengthened lock structure such that the lock achieves a dual locking effect and strengthens the triangular latch by means of variation in respect of material, shape, and structure to thereby achieve a multifunctional strengthening effect.

The multifunctional strengthened lock structure mainly comprises a case and a bolt control unit and a strengthened triangular latch unit arranged in the case. The bolt control unit at least comprises components including an own-axis rotating plate, a first push plate, a second push plate, a butterfly plate, and a first spring, a second spring, and a pressing member, and an arc arrestor. By means of a combination of such components, when a lock-cylinder rotating axle of the lock is rotated to close, the own-axis rotating plate is rotate to the closed position, and the second push plate is inoperable due to the butterfly plate being pushed to an idle position so as to serve as a blocking plate for the handle rotating axle, thereby achieving a dual-locking effect. And, a triangular latch comprises a latching head, a rod pivotally connected to the latching head, a strengthening ring fit over the rod, and a strengthening screw fastened to the latching head and the rod, so as to have the triangular latch achieve an effect of strengthening by means of variation in respect of material and shape.

In the above-described multifunctional strengthened lock structure, the strengthened triangular latch unit, comprises a latching head, a rod pivotally connected to the latching head, a strengthening ring fit over the rod, and a strengthening screw fastened to the latching head and the rod.

In the above-described multifunctional strengthened lock structure, the latching head of the strengthened triangular latch unit is formed with a fitting recess, and a positioning aperture is arranged in the fitting recess; the rod has an end formed with a pivot portion, and a mounting hole is formed in the pivot portion. To assemble, the strengthening ring is first fit over the pivot portion of the rod, and then, the pivot portion of the rod is fit into the fitting recess of the latching head, and afterwards, the strengthening screw is screwed into the positioning aperture of the latching head to penetrate through the mounting hole of the rod to thereby fix the rod to the latching head.

### BRIEF DESCRIPTION OF THE DRAWINGS

FIG. 1 is schematic view showing a multifunctional strengthened lock structure according to the present invention.

FIG. 2 is a schematic view showing an own-axis rotating plate according to the present invention.

FIG. 3 is a plan view showing the own-axis rotating plate according to the present invention.

FIG. 4 is a schematic view showing a first push plate according to the present invention.

FIG. 5 is plan vie showing the first push plate according to the present invention.

FIG. 6 is a schematic view showing a second push plate according to the present invention.

FIG. 7 is a plan view showing the second push plate according to the present invention.

FIG. 8 is a schematic view showing a butterfly plate according to the present invention.

FIG. 9 is a plan view showing the butterfly plate according to the present invention.

FIG. 10 is a schematic view showing a first spring according to the present invention.

FIG. 11 is a schematic view showing a second spring according to the present invention.

FIG. 12 is a schematic view showing a third spring according to the present invention.

FIG. 13 is an exploded view showing a strengthened triangular latch unit according to the present invention.

FIG. 14 is a cross-sectional view showing the strengthened triangular latch unit according to the present invention.

FIGS. 15 and 16 are schematic views illustrating operation of the present invention.

### DETAILED DESCRIPTION OF THE PREFERRED EMBODIMENT

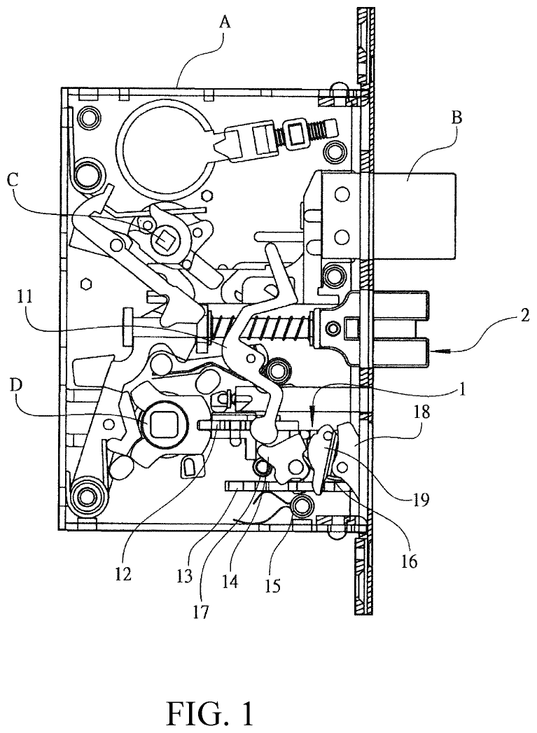

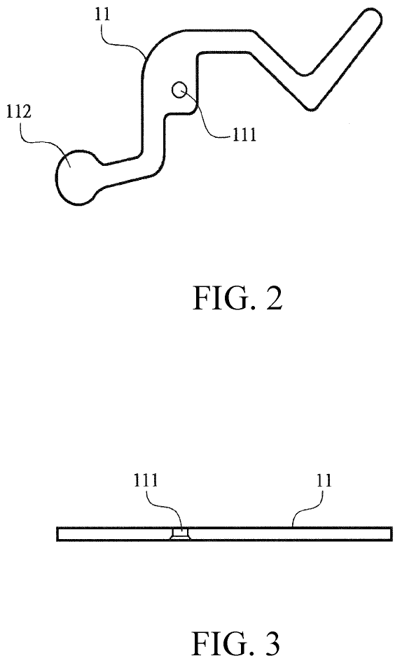

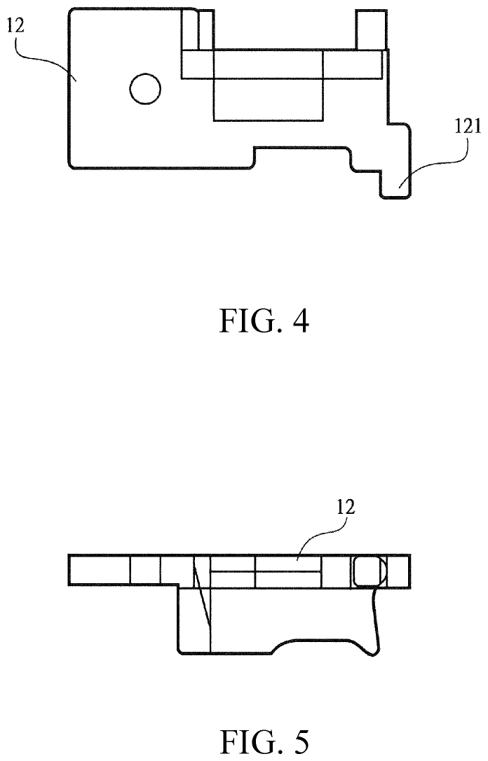

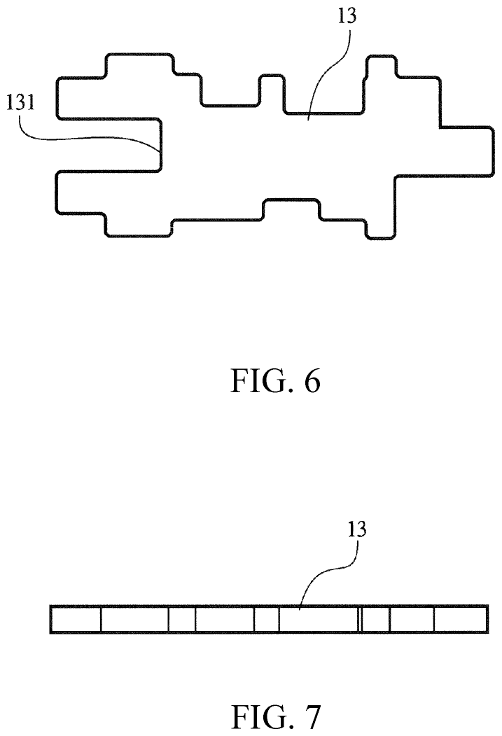

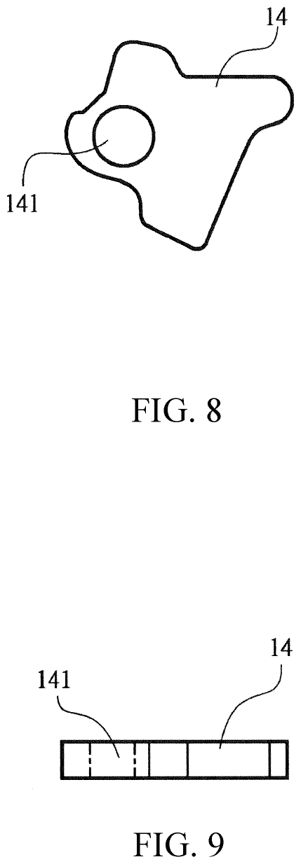

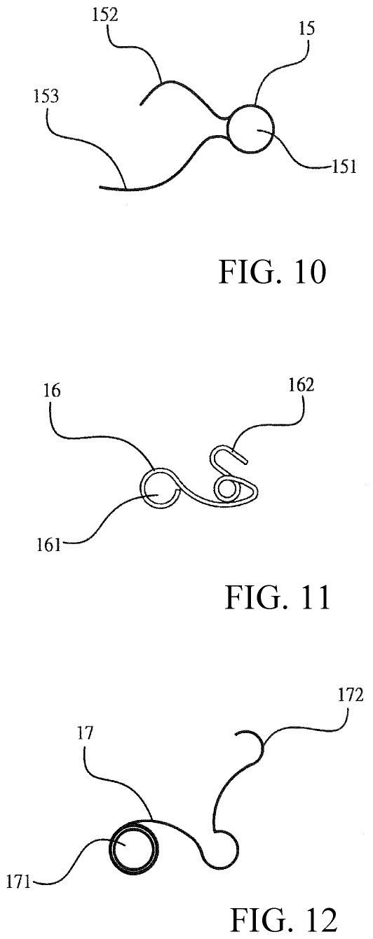

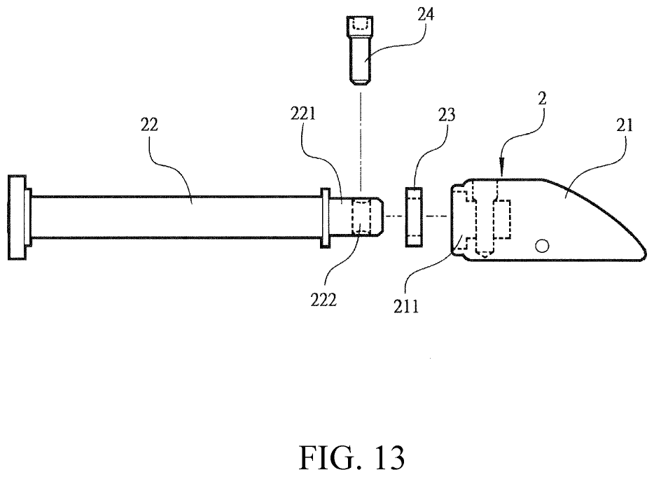

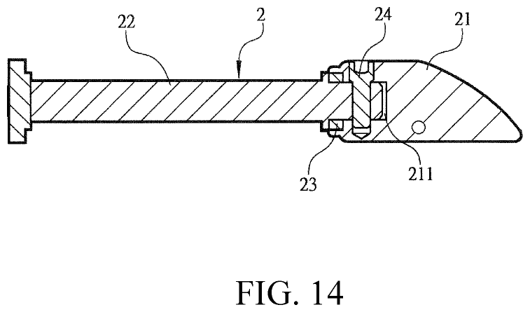

Referring jointly to FIGS. 1-14, diagrams of architecture of the present invention and structures of components thereof are shown. As shown in the drawings, the present invention comprises a case A and a square latch B, a lock-cylinder rotating axle C, and a handle rotating axle D arranged in the case A, and a bolt control unit 1, and a strengthened triangular latch unit 2. The bolt control unit 1 at least comprises components including an own-axis rotating plate 11, a first push plate 12, a second push plate 13, a butterfly plate 14, and a first spring 15, a second spring 16, a third spring 17, and a press button 18, and an arc arrestor 19. The own-axis rotating plate 11 is arranged between the square latch B and the bolt control unit 1 that is located on a lower side and is of a successively curved form having a center in which a mounting hole 111 is formed for mounting to the case A and a lower end formed with a supporting portion 112.

The first push plate 12 is arranged at one side of the handle rotating axle D and comprises a plate of an L-shape that is provided, on a rear side thereof, with a projection 121.

The second push plate 13 is arranged at a lower side of the first push plate 12 and is formed, in a side thereof, with a notch 131.

The butterfly plate 14 is arranged between the first push plate 12 and the second push plate 13 and is formed with a mounting hole 141 for mounting to the case A.

The first spring 15 comprises a ring portion 151 for mounting to a positioning peg A1 of the case A, and an upper supporting member 152 and a lower supporting member 153 extending from the ring portion 151. The upper supporting member 151 contacts and supports the second push plate 13, and the lower supporting member 153 contacts and supports on a lower wall surface of the case A.

The second spring 16 is arranged at a lower side of the butterfly plate 14 and comprises a ring portion 161 for mounting to the case A, and a retention portion 162 extending from the ring portion 161 and having a twisted shape.

The third spring 17 is arranged at a lower side of the butterfly plate 14 and comprises a ring portion 171 for mounting to the case A, and a retention portion 172 extending from the ring portion 171 and having a consecutively bent shape.

The strengthened triangular latch unit 2 comprises a latching head 21, a rod 22 pivotally connected to the latching head 21, a strengthening ring 23 fit over the rod 22, and a strengthening screw 24 fastened to the latching head 21 and the rod 22. The latching head 21 is formed with a fitting recess 211, and comprises a positioning aperture 212 arranged in the fitting recess 211. The rod 22 is formed, in one end thereof, with a pivot portion 221, and a mounting hole 222 is formed in the pivot portion 221. To assemble, the strengthening ring 23 is first fit over the pivot portion 221 of the rod 22, and then the pivot portion 221 of the rod 22 is fit into the fitting recess 211 of the latching head 21, and afterwards, the strengthening screw 24 is screwed into the positioning aperture 212 of the latching head 21 to penetrate through the mounting hole 222 of the rod 22 to thereby fix the rod 22 to the latching head 21, so as to achieve an effect of strengthening the triangular latch unit 2 by means of variation in respect of material, shape, and structure.

By means of a combination of such components, a multifunctional strengthened lock structure is formed. When the lock-cylinder rotating axle C is being rotated, the own-axis rotating plate 11 is rotated to a closed position, the second push plate 13 is inoperable due to the butterfly plate 14 being pushed to an idle position so as to serve as a blocking plate for the handle rotating axle D, thereby achieving a dual-locking effect to improve the effects of protection and burglary resistance for the lock. The triangular latch unit 2 is formed by assembling the latching head 21, the rod 22, the strengthening ring 23, and the strengthening screw 24, so that the triangular latch unit 2 may achieve an effect of strengthening by means of variation of material, shape, and structure, to thereby further strengthen the lock.

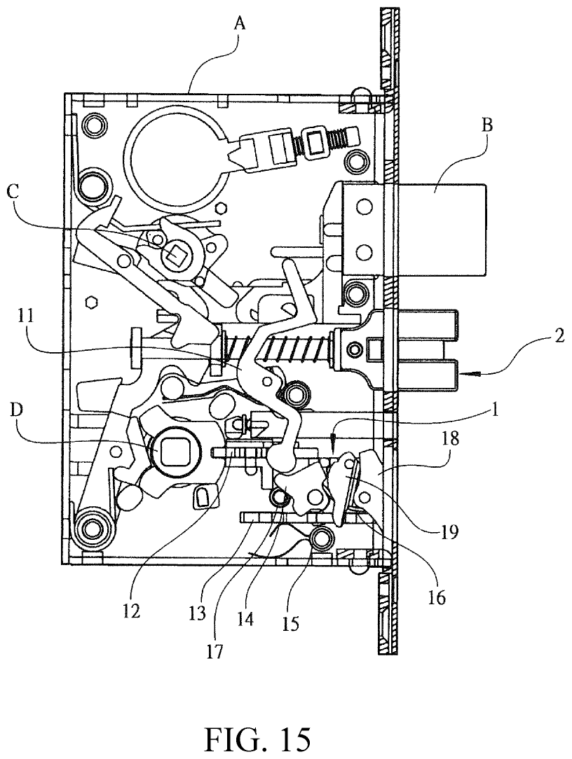

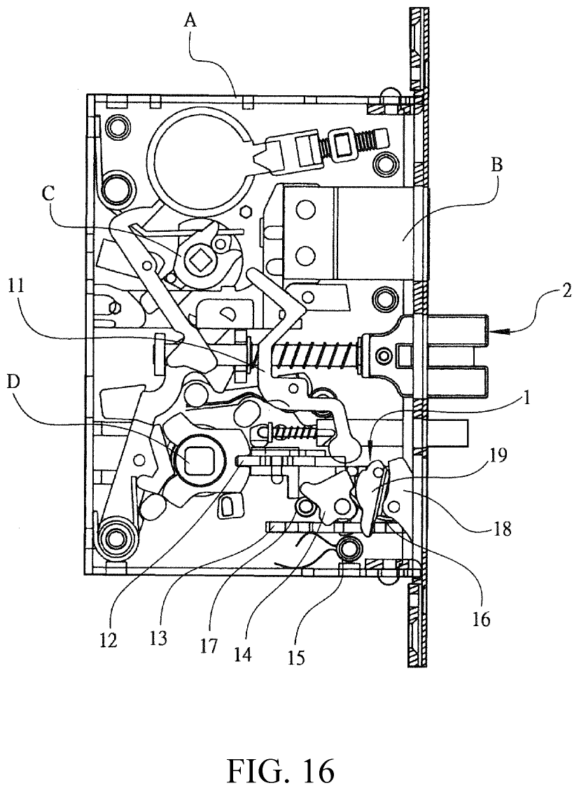

Referring to both FIGS. 15 and 16, schematic views of operation of the present invention are provided. As shown in the drawings, to operate the present invention, the lock-cylinder rotating axle C, which is located on the upper side, when rotated to push the square latch B outward, causes the own-axis rotating plate 11 to move, and the supporting portion 112 on the lower end of the own-axis rotating plate 11 in turn causes the first push plate 12 to move, so as to have the first push plate 12 pushes against the handle rotating axle D, making the handle rotating axle D not rotatable. Below the second push plate 13, the first spring 15 is arranged on the positioning peg A1, so that the first spring 15 may serve as a component for dampening and cushioning. When the lock-cylinder rotating axle C located on the upper side is being rotate to rotate the square latch B inwards, the own-axis rotating plate 11 returns to an open position, and the second push plate 13 is sprung back to the open position due to the second spring 16 and the third spring 17, so as to allow the first push plate 12 to retract out the handle rotating axle D, allowing the handle rotating axle D to freely rotate. As such, the lock achieves a dual-locking effect to thereby improve the effects of security and burglary resistance for the lock.

In the present invention, when the press button 18 is pushed to simultaneously rotate the arc arrestor 19, due to positioning of the second spring 16, the arc arrestor 19 drives the second push plate 13 to move, so as to cause the first push plate 12 to move into the handle rotating axle D, making the handle rotating axle D not rotating, also making the butterfly plate 14 block the first push plate 12. Due to the arrangement of the projection 121 on the rear side of the first push plate 12 at an angle, when the arc arrestor 19 is pushed to the closed position, a push bar of the arc arrestor 19 and a shape thereof may induce an effect of dual locking with respect to the rear of the first push plate 12 due to a time difference of the two positions. When the square latch B, and the own-axis rotating plate 11 is toward the closed position, due to the butterfly plate 14 being kept unaffected, the square latch B is incapable of controlling operation of the first push plate 12 on the lower side for opening and closing.

In summary, the present invention provides a strengthened triangular latch unit, in combination with the bolt control unit that is formed of the components of the first push plate, the second push plate, the butterfly plate, and the first spring, the second spring, and the press button, and the arc arrestor, to form a multifunctional strengthened lock structure. The lock is provided with a dual-locking effect, and the triangular latch achieves an effect of strengthening by means of variation in respect of material, shape, and structure, to thereby achieve the purposes of strengthening of the lock.

I claim:

1. A multifunctional strengthened lock structure, comprising:
a case, which is provided with a square latch, a bolt, and a lock-cylinder rotating axle, a handle rotating axle, and an own-axis rotating plate;
a strengthened triangular latch unit, which is arranged in the case and comprises a latching head, a rod pivotally connected to the latching head, a strengthening ring fit over the rod, and a strengthening screw fastened to the latching head and the rod; and
a bolt control unit, which comprises a first push plate arranged at one side of the handle rotating axle; a second push plate arranged at a lower side of the first push plate; a butterfly plate arranged between the first push plate and the second push plate; a first spring mounted to the case and having upper and lower ends respectively supported on the second push plate and a lower wall surface of the case; and a second spring and a third spring arranged at a lower side of the butterfly plate;
wherein by means of the triangular latch unit and the bolt control unit, the locked is strengthened and achieves a dual-locking effect to thereby improve effects of security and burglary resistance of the lock.

2. The multifunctional strengthened lock structure according to claim 1, wherein the first push plate comprises a plate in the form of an L-shape and has a projection formed on a rear side thereof.

3. The multifunctional strengthened lock structure according to claim 1, wherein the first spring comprises a ring portion for mounting to the case, and an upper supporting member and a lower supporting member extending from the ring portion, the upper supporting member supporting on the second push plate, the lower supporting member supporting on the lower wall surface of the case.

4. The multifunctional strengthened lock structure according to claim 1, wherein the second spring comprises a ring portion for mounting to the case, and a retention portion extending from the ring portion and having a twisted shape.

5. The multifunctional strengthened lock structure according to claim 1, wherein the third spring comprises a ring portion for mounting to the case, and a retention portion extending from the ring portion and having a consecutively bent shape.
